(19) United States
(12) Patent Application Publication
(10) Pub. No.: US 2004/0268384 A1
(43) Pub. Date: Dec. 30, 2004

(54) Method and apparatus for processing a video signal, method for playback of a recorded video signal and method of providing an advertising service

(76) Inventor: Christopher J. Stone, Newtown, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/609,637

(22) Filed: Jun. 30, 2003

(51) Int. Cl. H04N 7/025; H04N 7/10

(52) U.S. Cl. 725/32; 725/34

(57) ABSTRACT

A method for processing a broadcast video signal includes identifying a first advertising component within the video signal; creating control information based on predetermined characteristics of the first advertising component; and recording the video signal and the control information to form an encoded video signal, which is arranged in such a manner that a second advertising component is substitutable for the first advertising component based on a playback status of the encoded video signal.

### FIELD OF THE INVENTION

Aspects of this invention relate generally to video signal processing, and, more particularly, to a method and apparatus for processing a broadcast video signal, and to methods for playback of a recorded video signal and for providing an advertising service to a user of a personal video recorder.

### BACKGROUND OF THE INVENTION

Program providers such as television networks or stations, studios, Internet broadcasters or service providers, cable operators, satellite operators and the like, deliver video or audio programming to consumers via digital or analog signals. Advertisements are traditionally inserted into program interruptions, providing a medium for advertisers to reach large audiences, and a source of revenue for broadcasters.

Personal video recording devices such as VCRs, personal computer/television (PC/TV) devices and TiVO®, along with other recording devices, which may stand alone, or be included in devices such as set-top boxes, among other devices, allow consumers to control the recording of broadcast programming, and to watch recorded programs at a later time. Consumers may opt to receive fewer advertisements by controlling playback of the recorded programs—consumers may fast-forward through the advertisements, for example. Even when a consumer decides to receive a recorded advertisement, however, the advertisement may be out-of-date. As consumers record more programs and receive fewer relevant advertisements, broadcasters' advertising revenues may decline.

There are, therefore, needs for methods and devices for processing and playing back recorded broadcast programming, which enable delivery of relevant advertisements likely to be seen by viewers of the recorded programs.

### SUMMARY OF THE INVENTION

According to one aspect of the present invention, a method for processing a broadcast video signal includes identifying a first advertising component within the video signal; creating control information based on predetermined characteristics of the first advertising component; and recording the video signal and the control information to form an encoded video signal, which is arranged in such a manner that a second advertising component is substitutable for the first advertising component based on a playback status of the encoded video signal.

According to another aspect of the present invention, a method for playback of a recorded video signal having a first advertising component and control information based on predetermined characteristics of the first advertising component, includes detecting a playback status of the first advertising component; and based on the control information and the playback status, playing a second advertising component instead of playing the first advertising component.

According to a further aspect of the present invention, an apparatus for processing a video signal includes a computer-readable storage medium and a processor responsive to the computer-readable storage medium and to a software program. When the software program is loaded into the processor, it is operative to identify a first advertising component within the video signal; create control information based on predetermined characteristics of the first advertising component; create an encoded video signal based on the video signal and the control information; and cause the encoded video signal to be recorded on the computer-readable storage medium in such a manner that a second advertising component is substitutable for the first advertising component based on a playback status of the encoded video signal.

According to a still further aspect of the present invention, a method of providing an advertising service to a user of a personal video recorder, which has stored thereon a broadcast video signal having an original advertising component, includes providing access to a plurality of replacement advertising components; causing at least one of the replacement advertising components to be accessed by the personal video recorder; and based on a playback status of the original advertising component, causing the personal video recorder to substitute the at least one of the accessed replacement advertising components for the original advertising component.

### BRIEF DESCRIPTION OF THE DRAWINGS

FIG. 1 is a block diagram of a video signal handling system, in accordance with various aspects of the present invention.

FIG. 2 is a flowchart of a method for processing a broadcast video signal, in accordance with one aspect of the present invention.

FIG. 3 is a flowchart of a method for playback of a recorded video signal, in accordance with another aspect of the present invention.

### DETAILED DESCRIPTION

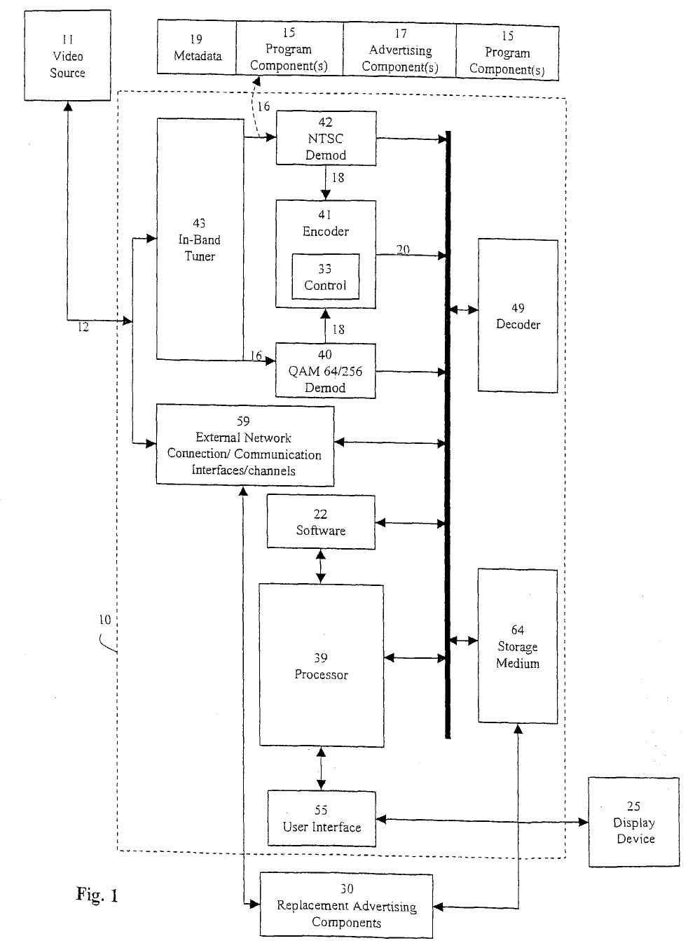

Turning now to the drawings, where like numerals designate like components, FIG. 1 is a block diagram of a video signal handling system 10 (“system 10”). System 10 receives video signal 12 from video source 11. As shown, system 10 is a cable set-top box, video source 11 is a hybrid fiber-optic/coax cable network operated by a cable television operator, and video signal 12 is a multi-channel analog and/or digital programming source broadcast by the cable operator. System 10, however, may be any device or combination of devices capable of receiving, recording and playing back video signal 12; video source 11 may be any public or private, wired or wireless, video transmission infrastructure or technology, including but not limited to a fiber-optic network, a coaxial cable network, a hybrid network, a satellite network, cellular network, the Internet, a television network, a radio network, a copper wire network, or any other existing or future transmission infrastructure or technology, operated by any type of program provider, such as a television network or station, a studio, an Internet broadcaster or service provider, a cable operator, or a satellite operator; and video signal 12 may be any pre-recorded or live analog or digital electronic signal representing an image and/or audio, in any format.

System 10 includes external network connection/communication interfaces 59, which support devices such as modems, streaming media players and other network connection support devices and/or software, coupled through local or wide area networks (not shown) to program providers and providers of other content, such as advertising content (discussed further below).

System 10 further includes an in-band tuner 43, which tunes to a channel signal 16 selected by a consumer (not shown) via user interface 55. User interface 55 may be any type of known or future device or technology allowing the consumer to select channels or programs the consumer wishes to receive, but is preferably a remote control, mouse, microphone, keyboard, or display associated with a personal video recorder.

Channel signal 16 includes video and/or audio components, which represent one or more program components 15, and one or more advertising components 17. As shown, advertising components 17 are inserted into interruptions in program components 15. Advertising components 17 may be provided from any source, and may be in any form.

Channel signal 16 also preferably includes specific information and control data 19, typically referred to as metadata, inserted into channel signal 16 prior to broadcast (for example, during program creation and editing, or by a local system operator or station), in accordance with well-known methods and techniques, which describes attributes or characteristics of program components 15 and advertising components 17 within channel signal 16. Metadata 19 may, among other things, identify titles and start and ending times associated with program components 15, and identify sources and durations of advertising components 17, as well as indicate whether adverting components 17 are date-sensitive. Examples of date-sensitive advertisements include advertisements regarding sales or special events that do not continue after beyond certain dates. Other signals or markers in channel signal 16 may be used instead of metadata 19 to identify program components 15 and advertising components 17, including but not limited to logical or contextual inferences based on information within channel signal 16, such as vertical blanking intervals and other such signals or markers.

Demodulators 40 and 42 are responsive to in-band tuner 43. Demodulator 40, which may be a 64/256 quadrature amplitude modulation demodulator, is responsive to receive a digital version of channel signal 16. Demodulator 40 identifies digital data packets from one or more digital sources, such as a Moving Pictures Experts' Group (MPEG) transport stream, a high-definition television stream, or a media stream from an external network connection 59, such as a cable modem, using well-known methods and techniques. Demodulator 42, which may be an NTSC demodulator, is responsive to receive an analog version of channel signal 16 and to decode signals and markers according to well-known methods and techniques. Demodulators 40 and 42 are operative to output video information 18.

Video information 18 includes raw video or audio data, arranged for formatting in accordance with a predetermined media format. Video information 18 is preferably arranged in accordance with an MPEG media format, such as an MPEG-2 media format, but may be arranged in accordance with other media formats, including but not limited to other MPEG formats, Hypertext Markup Language (HTML), Virtual Hypertext Markup Language (VHTML), X markup language (XML), H.261, or H.263 formats. Video information 18 that is not pre-encoded in accordance with aspects of the present invention is passed to encoder 41, while pre-encoded video information may be passed directly to a storage medium 64 (discussed further below), or to a display device 25 (also discussed further below).

In accordance with an aspect of the present invention, encoder 41 is operative to perform predetermined coding techniques to arrange video information 18 into an MPEG-2 transport stream, and to produce encoded video signal 20 for transmission, or for storage in storage medium 64. Specifically, encoder 41 creates control information 33 based on metadata 19 or other signals within channel signal 16, and appends control information 33 to, or embeds it within, the MPEG-2 transport stream. As discussed further below, control information 33 enables identification, extraction and replacement of advertising components 17 from encoded video signal 20 during or prior to playback of encoded video signal 20. Control information 33 may include, but is not limited to, an information or program management table, header codes identifying particular slices of image frames associated with advertising components 17, and/or dummy packs (not shown) inserted into an MPEG-2 transport stream. Dummy packs may include one or more replacement-advertising components 30 (discussed further below), or instructions for accessing such replacement-advertising components 30. Internal arrangements of encoder 41 are well known, and may include analog-to-digital converters, video encoders, audio encoders, one or more storage media and/or buffers, and general or special-purpose processors or application-specific integrated circuits. A suitable MPEG coding scheme may be selected and implemented by one skilled in the art, according to well-known procedures and algorithms developed for MPEG.

Storage medium 64 is responsive to receive, among other things, encoded video signal 20 for storage. Storage medium 64 may be any local or remote device, now known or later developed, capable of recording data, including but not limited to a hard disk drive, a videocassette recorder tape, all types of compact disks and digital videodisks, a magnetic tape, a home router, or a server.

Decoder 49 is responsive to receive recorded encoded video signal 20 from storage medium 64, and to play back recorded encoded video signal 20 via display device 25, in response to instructions from user interface 55 and/or control information 33. Decoder 49 is also responsive to receive and pass through video programming directly from tuner 43. Internal arrangements of decoder 49 are well known—decoder 49 may include analog-to-digital converters, one or more storage media and/or buffers, and general or special-purpose processors or application-specific integrated circuits, along with demultiplexors for demultiplexing and/or synchronizing at least two transport streams, for example, video and audio. Video and audio decoders and/or analog and digital decoders may be separate, with communication between separate decoders allowing for synchronization, error correction and control.

Display device 25, which also includes speakers for outputting audio signals, displays video programming received from tuner 43 or storage medium 64. Display device 25 is responsive to receive analog or digital signals, including but not limited to S-video, composite audio-video, SPDIF, and DVI.

Processor 39 and software 22 are illustrated functionally, and are responsive to various elements of system 10, including demodulators 40 and 42, encoder 41, storage medium 64 and decoder 49. When loaded into a processor, such as processor 39, software 22 is operative to control encoding, recording and playback of encoded video signal 20, including and locating, selecting and inserting replacement advertising components 30 (discussed further below). It will be appreciated, however, that aspects of the present invention are not limited to any specific embodiments of computer software or signal processing methods. For example, one or more processors packaged together or with other elements of system 10 may implement functions of processor 39 in a variety of ways. It will also be appreciated that software 22 may be any stored instructions, in one or more parts (stored, for example, on storage medium 64, or another internal or external storage medium such as a read-only-memory or a random-access memory) electronically controlling functions provided by system 10, including firmware, and may be used or implemented by one or more elements, including one or more processors, of system 10.

During normal operation of system 10 in accordance with aspects of the present invention, a consumer using user interface 55 selects recorded programming for playback. An encoded video signal 20 associated with the selected programming is transferred from storage medium 64 to decoder 49 for processing. Decoder 49 demultiplexes and decodes encoded video signal 20 for presentation to the consumer via display device 25. During playback of encoded video signal 20, the consumer may receive one or more advertising components 17 during interruptions in video program components 15.

According to one aspect of the present invention, when the consumer does not wish to receive a particular advertising component 17, and issues a fast-forward command via user interface 55 during playback of advertising component 17, control information 33 within encoded video signal 20 is used to extract the fast-forwarded advertising component 17, and to replace it with a selected replacement-advertising component 30 (discussed further below) displayed at a normal speed, in the same (or shorter) time frame as occupied by fast-forwarded advertising component 17.

According to another aspect of the present invention, when the consumer opts to receive a particular advertising component 17 during playback of video programming, and control information 33 within encoded video signal 20 indicates that advertising component 17 is out of date, a replacement-advertising component 30 (discussed further below) is selected and displayed in place of the out-of-date advertising component, in the same (or shorter) time frame as occupied by the out-of-date advertising component.

Replacement-advertising components 30 may be traditional commercials, product demonstrations, music clips, video clips or any other content in any form, provided from any source. Replacement-advertising component 30 may be selected based on one or more predetermined criteria, including but not limited to a source of fast-forwarded advertising component 17, a location of replacement-advertising component 30, predetermined user preferences, a date of fast-forwarded advertising component 17, and a duration of fast-forwarded advertising component 17, both at normal speed and at various fast-forward speeds. And the process of selecting replacement-advertising components 30 may include the use of a predetermined function to calculate a maximum time frame to be occupied by a particular replacement-advertising component 30, to ensure that the duration of replacement-advertising component 30 is not greater than the normal, or fast-forwarded, duration of original advertising component 17. Such a function may consider the duration of original advertising component 17, the playback speed selected by the consumer, or other information.

Replacement-advertising components 30 may be configured to have various durations and/or content. For example, advertising content providers may produce several versions of a replacement-advertising component 30. Different versions of replacement-advertising components 30 may have different durations, and a particular duration may be selected based on the length of original advertising component 17 played at various user-selectable speeds, for example, normal speed, 2×, 4×, 10×, and other standard speeds. Content providers may utilize well-known techniques from the movie and television to produce alternative versions of replacement-advertising components 30. For example, the recording rate of original video content may be altered—a video may be recorded at a slower rate than normal, so that when it is played back at a faster rate, the video appears at normal speed.

Replacement advertising components 30 may be stored locally, for example on storage medium 64, or remotely, in one or more locations, such as directories, servers, or dedicated communication channels or data carousels. System 10 may be configured to search or consult a predetermined list of directories, channels or servers for the existence of new replacement-advertising components 30 (or addresses thereof), or new replacement-advertising components 30 may be “pushed” to system 10 via a remote operator, such as a cable operator. Remote locations or downloads may be accessed or accomplished via external network connection/communication interfaces 59, or via an in-band file download mechanism, for example, DSM-CC.

Replacement-advertising components 30 may be retrieved or selected during playback of recorded encoded video signal 20, or may be retrieved or selected prior to encoding of video information 18. During playback of replacement-advertising components 30, it is preferable to disable user inputs such as fast-forward and/or reverse, but otherwise system 10 preferably processes other user commands received via user interface 55 in a standard manner.

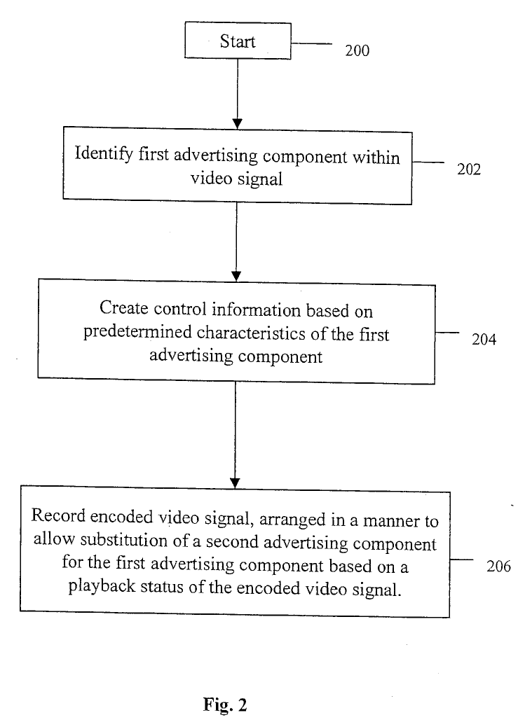

FIG. 2 is a flowchart of a method, which may be implemented by system 10, for processing a broadcast video signal 16 received from video source 11, in accordance with an aspect of the present invention. The method starts at block 200 and continues at block 202, where a first advertising component 17 is identified within video signal 16. First advertising component 17 may be identified based on metadata 19 within video signal 16, or using another method or technique, such as detecting predetermined signals or patterns within video signal 16. At block 204, control information 33 is created based on predetermined characteristics of first advertising component 17. Control information 33 may include characteristics such as a duration of first advertising component 17, a calculation of a playback time of first advertising component 17 (including playback times at various predetermined fast-forward speeds), a date indicator associated with first advertising component 17, which may indicate whether the advertising component is date-sensitive, or any other characteristic of first advertising component 17. Control information 33 may further specify a location of, or may include, one or more potential second advertising components 30, which would be retrieved (from a variety of locations, including storage medium 64, a remote memory such as a server (not shown) or a dedicated communication channel via external network connection/communication interfaces 59) and substituted for first advertising component 17 prior to recording or during playback. An encoded video signal 20, which includes control information 33, is recorded at block 206, preferably according to an MPEG standard. Encoded video signal 20 is arranged in a manner that allows a second advertising component 30 to be substituted for first advertising component 17 based on a playback status of encoded video signal 20.

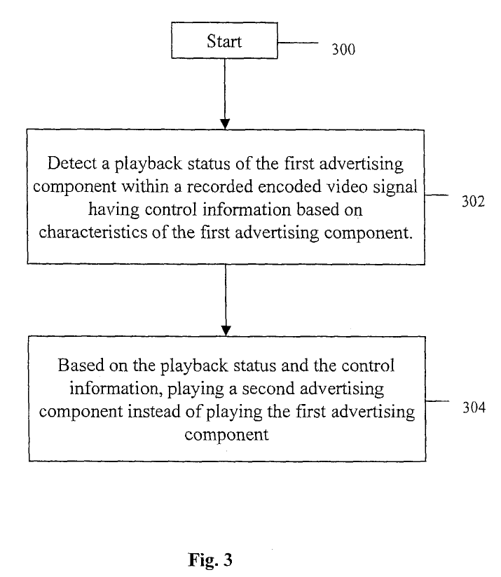

In accordance with another aspect of the present invention, FIG. 3 is a flowchart of a method for playback of a recorded video signal, such as encoded video signal 20 (which includes, among other things, first advertising component 17 and control information 33 based on predetermined characteristics of first advertising component 17), processed and recorded in accordance with the method set forth in the flowchart of FIG. 2. The method begins at block 300, and continues at block 302, where a playback status of first advertising component 17 is detected. Control information 33 may serve as an indicator that first advertising component 17 is being played back. If predetermined characteristics of first advertising component 17 indicate that it is a candidate for replacement, for example, first advertising component 17 is date-sensitive, or if a consumer fast-forwards during playback of first advertising component 17, then, at block 304, based on control information 33 and the playback status, a second advertising component 30 is played instead of playing first advertising component 17.

Methods illustrated in the flowcharts of FIGS. 2 and 3 may be implemented by any stored instructions, such as software 22. When loaded into a processor, such as processor 39, software 22 would operate to control encoding, recording and playback of encoded video signal 20, including locating, selecting and inserting replacement advertising components 30. As indicated above, however, it will be appreciated that aspects of the present invention are not limited to any specific embodiments of computer software or signal processing methods.

Although a specific architecture has been described herein, including specific functional elements and relationships, it is contemplated that the systems and methods herein may be implemented in a variety of ways. For example, functional elements may be packaged together or individually, or may be implemented by fewer, more or different devices, and may be either integrated within other products, or adapted to work with other products externally. When one element is indicated as being responsive to another element, the elements may be directly or indirectly coupled.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

1. A method for processing a broadcast video signal, comprising:
identifying a first advertising component within the video signal;
creating control information based on predetermined characteristics of the first advertising component; and
recording the video signal and the control information to form an encoded video signal, the encoded video signal arranged in such a manner that a second advertising component is substitutable for the first advertising component based on a playback status of the encoded video signal.

2. A computer-readable storage medium having stored thereon one or more software programs which, when executed, implement the method of claim 1.

3. The computer-readable storage medium according to claim 2, wherein the one or more software programs are responsive to a personal video recorder.

4. The method according to claim 1, wherein the second advertising component is substituted for the first advertising component prior to recording the encoded video signal.

5. The method according to claim 4, wherein a location of the second advertising component is one of a local memory; a remote memory; and a dedicated communication channel.

6. The method according to claim 1, wherein the step of identifying the first advertising component within the video signal comprises detecting metadata within the video signal.

7. The method according to claim 6, wherein the control information comprises metadata.

8. The method according to claim 6, wherein the predetermined characteristics comprise one of a playback time of the first advertising component and a date indicator associated with the first advertising component.

9. The method according to claim 1, wherein the video signal is encoded according to a moving pictures experts group (MPEG) standard.

10. A method for playback of a recorded video signal, the recorded video signal having a first advertising component and control information based on predetermined characteristics of the first advertising component, comprising:
detecting a playback status of the first advertising component; and
based on the control information and the playback status, playing a second advertising component instead of playing the first advertising component.

11. A computer-readable storage medium having stored thereon one or more software programs which, when executed, implement the method of claim 10.

12. The method according to claim 10, further comprising:
prior to playing the second advertising component, retrieving the second advertising component; and
after retrieving the second advertising component, substituting the second advertising component for the first advertising component based on the playback status of the first advertising component.

13. The method according to claim 12, wherein the second advertising component is retrieved from one of a local memory; a remote memory; and a dedicated communication channel.

14. The method according to claim 13, further comprising:
substituting the second advertising component for the first advertising component during playback of the encoded video signal.

15. The method according to claim 14, wherein the predetermined characteristics comprise one of a playback time of the first advertising component and a date indicator associated with the first advertising component.

16. The method according to claim 15, wherein the first advertising component has a first playback speed, and the second advertising component has a second playback speed.

17. The method according to claim 16, wherein the first playback speed is faster than the second playback speed.

18. The method according to claim 17, further comprising:
detecting a user input requesting playback of the first advertising component at the first speed; and
in response to detecting the user input, and based on the playback time of the first advertising component, instead of playing the first advertising component at the first speed, playing the second advertising component at the second speed, the second advertising component at the second speed having a playback time substantially equivalent to the playback time of the first advertising component at the first speed.

19. The method according to claim 15, further comprising:
based on the date indicator, determining that the first advertising component is date-sensitive; and
in response to detecting that the first advertising component is date-sensitive, instead of playing the first advertising component, playing the second advertising component.

20. An apparatus for processing a video signal, comprising:
a computer-readable storage medium; and
a processor responsive to the computer-readable storage medium and to a software program, the software program, when loaded into the processor, operative to:
identify a first advertising component within the video signal;
create control information based on predetermined characteristics of the first advertising component;
create an encoded video signal based on the video signal and the control information; and
cause the encoded video signal to be recorded on the computer-readable storage medium in such a manner that a second advertising component is substitutable for the first advertising component based on a playback status of the encoded video signal.

21. A method of providing an advertising service to a user of a personal video recorder, the personal video recorder having stored thereon a broadcast video signal having an original advertising component, the method comprising:
providing access to a plurality of replacement advertising components;
causing at least one of the replacement advertising components to be accessed by the personal video recorder; and
based on a playback status of the original advertising component, causing the personal video recorder to substitute the at least one of the accessed replacement advertising components for the original advertising component.
